(19) United States
(12) Patent Application Publication
(10) Pub. No.: US 2025/0124585 A1
(43) Pub. Date: Apr. 17, 2025

(54) IMAGING APPARATUS, SUBJECT DEPTH ESTIMATION METHOD, AND PROGRAM

(71) Applicant: Japan Display Inc., Tokyo (JP)

(72) Inventors: Hitoshi TANAKA, Tokyo (JP); Hirondo NAKATOGAWA, Tokyo (JP); Yoshiro AOKI, Tokyo (JP)

(21) Appl. No.: 19/002,940

(22) Filed: Dec. 27, 2024

Related U.S. Application Data
(63) Continuation of application No. PCT/JP2023/014410, filed on Apr. 7, 2023.

(30) Foreign Application Priority Data
Jun. 28, 2022 (JP) 2022-103327

(51) Int. Cl. G06T 7/50; G06T 7/13; G06T 9/00; G06V 10/56

(52) U.S. Cl. CPC G06T 7/50; G06T 7/13; G06T 9/00; G06V 10/56; G06V 2201/07

(57) ABSTRACT

Provided is a subject depth estimation method including the steps of obtaining a non-masked captured image by imaging a subject in a state where no mask is installed, determining a representative edge direction based on an edge image included in the non-masked captured image, selecting, from among a plurality of masks prepared in advance, a combination of the masks with a relatively highest depth estimation accuracy of an object corresponding to an image representing an edge in an equal direction to the representative edge direction, obtaining a plurality of masked captured images by imaging the subject using each of the masks included in the selected combination of the masks, and calculating a depth estimation value of the subject at each of a plurality of positions by performing decoding processing based on a point spread function unique to each of the masks selected on the plurality of masked captured images.

### CROSS REFERENCES TO RELATED APPLICATIONS

The present application is a continuation of International Application No. PCT/JP2023/014410 filed on Apr. 7, 2023 and claims priority to Japanese Patent Application No. 2022-103327 filed on Jun. 28, 2022, the disclosure of which is incorporated herein by reference.

### BACKGROUND

The present invention relates to an imaging apparatus, a subject depth estimation method, and a program.

In the field of coded imaging, a technique called depth from defocus (DFD) is known. The DFD technique is a technique for estimating a distance from an optical system of an imaging apparatus to a subject, that is, a deepness or a depth of the subject based on the degree of blurring of an edge appearing in an image obtained by imaging.

The DFD technique is described in, for example “Coded Aperture Pairs for Depth from Defocus and Defocus Deblurring” C. Zhou, S. Lin and S. K. Nayar, International Journal of Computer Vision, Vol. 93, No. 1, pp. 53, May. 2011 (Non-Patent Document 1). In the DFD technique described in Non-Patent Document 1, two masks having apertures through which light passes are in different positions are prepared. Subsequently, coded imaging is performed for each of the two masks, in which the mask is arranged in the light incident region of an optical system and the same subject is imaged. Subsequently, the two captured images obtained by the coded imaging are subjected to decoding processing based on a point spread function unique to each mask, and the depth of the subject is estimated. Note that the point spread function is generally called a point spread function (PSF), and is also called a blurring function, a blurring spread function, a point image distribution function, or the like.

### SUMMARY

The DFD technique is still developing, and there is much room for improvement in practicality of the DFD technique. Due to the above circumstances, a more practical DFD technique is desired.

An outline of a typical embodiment out of embodiments of the invention disclosed in the present application will be described as follows.

A representative embodiment of the present invention is an imaging apparatus including: an optical system on which light from a subject is incident; an imaging element which receives the light passing through the optical system; a mask installation unit which creates a state in which any of a plurality of masks prepared in advance is installed and a state in which none of the masks is installed in an incident region of the light incident on the optical system from the subject; and an arithmetic and control unit which outputs a signal for controlling the mask installation unit and the imaging element so that the subject is imaged and acquires a non-masked captured image of the subject and a masked captured image of the subject, in which the arithmetic and control unit performs non-masked imaging processing of obtaining the non-masked captured image by imaging the subject in a state where no mask is installed, determination processing of determining a representative edge direction based on an edge image included in the non-masked captured image, selection processing of selecting, from among the plurality of the masks prepared in advance, a combination of the masks with a relatively highest depth estimation accuracy of an object corresponding to an image representing an edge in an equal direction to the representative edge direction, masked imaging processing of obtaining a plurality of masked captured images by imaging the subject using each of the masks included in the selected combination of the masks, and decoding processing of obtaining information indicating a depth of the subject at each of a plurality of positions by performing decoding, based on a point spread function unique to each of the masks selected, on the plurality of masked captured images.

A representative embodiment of the present invention is a subject depth estimation method including: obtaining a non-masked captured image by imaging a subject in a state where no mask is installed; determining a representative edge direction based on an edge image included in the non-masked captured image; selecting, from among a plurality of masks prepared in advance, a combination of the masks with a relatively highest depth estimation accuracy of an object corresponding to an image representing an edge in an equal direction to the representative edge direction; obtaining a plurality of masked captured images by imaging the subject using each of the masks included in the selected combination of the masks; and obtaining information indicating a depth of the subject at each of a plurality of positions by performing decoding, based on a point spread function unique to each of the masks selected, on the plurality of masked captured images.

A representative embodiment of the present invention is a program for causing a computer to perform: non-masked imaging processing of obtaining a non-masked captured image by imaging a subject in a state where no mask is installed; determination processing of determining a representative edge direction based on an edge image included in the non-masked captured image; selection processing of selecting, from among a plurality of the masks prepared in advance, a combination of the masks with a relatively highest depth estimation accuracy of an object corresponding to an image representing an edge in an equal direction to the representative edge direction; masked imaging processing of obtaining a plurality of masked captured images by imaging the subject using each of the masks included in the selected combination of the masks; and decoding processing of obtaining information indicating a depth of the subject at each of a plurality of positions by performing decoding, based on a point spread function unique to each of the masks selected, on the plurality of masked captured images.

### BRIEF DESCRIPTION OF THE DRAWINGS

FIG. 1 is a diagram illustrating an example of an imaging system and an arithmetic and control device used in a subject depth estimation method according to a first embodiment.

FIG. 2 is a flowchart illustrating an example of a procedure by the subject depth estimation method according to the first embodiment.

FIG. 3 is a diagram illustrating an example of a plurality of masks.

FIG. 4 is a diagram illustrating a correspondence relationship between a combination of masks and an edge direction having high depth estimation accuracy.

FIG. 5 is a diagram for explaining a first method for determining a representative edge direction.

FIG. 6 is a diagram for explaining a second method for determining a representative edge direction.

FIG. 7 is a diagram for explaining a third method for determining a representative edge direction.

FIG. 8 is a diagram illustrating an example of a blurred edge image.

FIG. 9 is a diagram illustrating an example of a sharp edge image.

FIG. 10 is a diagram illustrating an example of a configuration of an imaging apparatus according to a second embodiment.

FIG. 11 is a diagram illustrating an example of a liquid crystal mask unit.

FIG. 12 is a diagram illustrating an example of a configuration of an arithmetic and control unit according to the second embodiment.

FIG. 13 is a flowchart illustrating an example of a procedure of operation of the imaging apparatus according to the second embodiment.

FIG. 14 is a diagram for describing a procedure from non-masked imaging processing to mask selection processing.

FIG. 15 is a diagram illustrating an example of a plurality of types of combinations of masks according to a first modification example.

FIG. 16 is a diagram illustrating an example of combinations of masks according to a second modification example.

FIG. 17 is a diagram illustrating an example of a plurality of masks used in a DFD technique.

### DESCRIPTIONS OF THE PREFERRED EMBODIMENTS

Before describing each embodiment of the present invention, basic contents of the DFD technique and problems that the present inventors have found will be described.

The state of defocus (hereinbelow, referred to as blurring) of a captured image generally depends on a point spread function determined by an optical system of an imaging apparatus, a shape of a light incident region of the optical system, and the like. In a case where a mask that partially shields light is installed in the light incident region of the optical system, the point spread function is determined for each mask. Imaging of a subject with an imaging apparatus in which a mask is installed is called coded imaging. When the subject is subjected to coded imaging, a blurred image is acquired based on the point spread function unique to the mask used.

When decoding processing of performing deconvolution based on the point spread function unique to the mask used is performed on the blurred image, a decoded image in which blurring is improved and depth information of an object corresponding to each position in the decoded image are obtained.

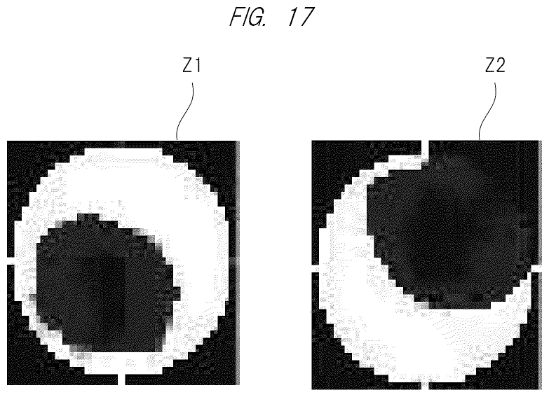

FIG. 17 is a diagram illustrating an example of a plurality of masks used in the DFD technique. Non-Patent Document 1. describes a DFD technique by coded imaging using two masks Z1 and Z2 illustrated in FIG. 17. In the two masks Z1 and Z2 illustrated in FIG. 17, the black region is a region that shields light incident on the optical system, and the white region is a region of an aperture that allows light incident on the optical system to pass therethrough. In this manner, the two masks Z1 and Z2 illustrated in FIG. 17 have different geometric patterns of apertures through which light can pass.

On the other hand, h as a result of examining the DFD technique by coded imaging using the plurality of masks having different geometric patterns of apertures, the present inventors have found that there is an image with low depth estimation accuracy among images in each of which an object appears. Specifically, the image with low depth estimation accuracy is an edge image representing an edge along a direction close to a positional difference direction of apertures of masks used.

In the edge image representing the edge along the positional difference direction of the apertures of the two masks used in the DFD technique, the degree of blurring hardly changes between the captured image using the first mask and the captured image using the second mask. In the case of the two captured images between which the degree of blurring does not change, it is considered that depth information is not accurately extracted even in a case where decoding processing by deconvolution based on a point spread function unique to each mask is performed.

Therefore, in a case where the edge direction of a representative edge of interest among the edges in the captured image is the same as or close to the edge direction in which the difference in the degree of blurring hardly occurs, the depth of the object corresponding to the edge image that is regarded as important cannot be estimated with high accuracy.

Due to the above circumstances, in the DFD method of imaging the same subject using a plurality of masks and estimating the depth of the subject, a technique capable of, for an edge image of a representative edge direction in the captured image, estimating the depth of the corresponding object with more stable and higher accuracy is desired.

In view of the above circumstances, the present inventors have devised the present invention as a result of intensive studies. Hereinbelow, each embodiment of the present invention will be described. Note that each embodiment described below is an example for carrying out the present invention, and does not limit the technical scope of the present invention. In addition, in each of the following embodiments, components having the same functions are denoted by the same reference signs, and repeated description thereof will be omitted unless particularly necessary.

### First Embodiment

A subject depth estimation method according to a first embodiment of the present application will be described. A subject depth estimation method according to a first embodiment of the present application is a subject depth estimation method including obtaining a non-masked captured image by imaging a subject in a state where no mask is installed, determining a representative edge direction based on an edge image included in the non-masked captured image, selecting, from among a plurality of masks prepared in advance, a combination of the masks with a relatively highest depth estimation accuracy of an object corresponding to an image representing an edge in an equal direction to the representative edge direction, obtaining a plurality of masked captured images by imaging the subject using each of the masks included in the selected combination of the masks, and obtaining information representing a depth of the subject at each of a plurality of positions by performing decoding, based on a point spread function unique to each of the masks selected, on the plurality of masked captured images. Details of the subject depth estimation method are as follows.

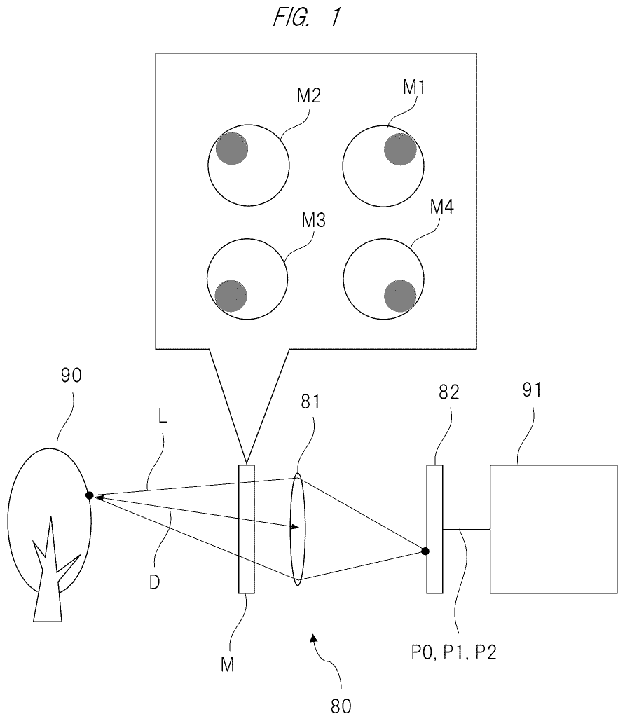

FIG. 1 is a diagram illustrating an example of an imaging system and an arithmetic and control device used in a subject depth estimation method according to the first embodiment.

As illustrated in FIG. 1, an imaging system 80 includes an optical system 81, an imaging element 82, and a mask M. The optical system 81 mainly includes a lens or the like, collects light L coming from a subject 90, and forms an image on a light receiving surface of the imaging element 82. The imaging element 82 is an electronic component that performs photoelectric conversion, photoelectrically converts brightness due to light of the image formed on the light receiving surface into a charge amount, and instantaneously captures a photoelectrically converted electric signal to obtain a captured image.

The mask M is a so-called optical filter that allows part of the light L incident on the optical system 81 to pass therethrough and shields the other part of the light L. The mask is also referred to as a coded aperture, an aperture, or the like.

An arithmetic and control device 91 is connected to the imaging element 82. The arithmetic and control device 91 performs various types of processing on the captured image obtained based on the electric signal from the imaging element 82 to obtain various types of information. The arithmetic and control device 91 is, for example, a computer.

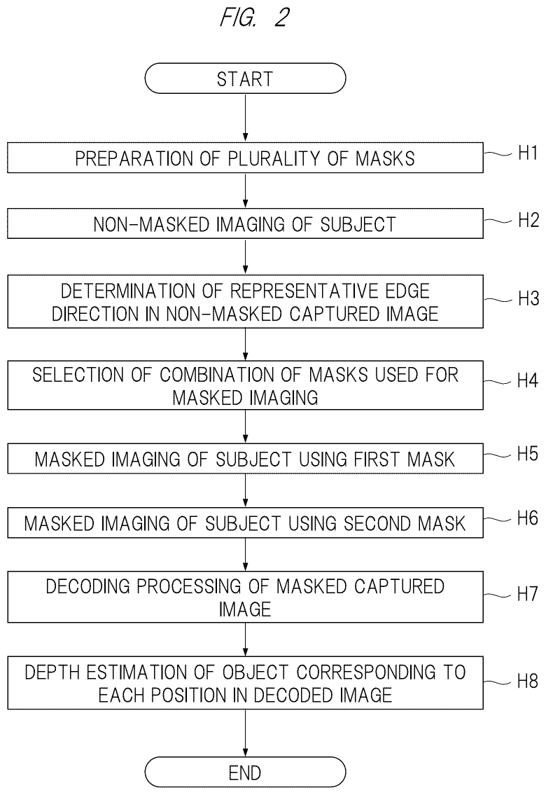

FIG. 2 is a flowchart illustrating an example of a procedure by the subject depth estimation method according to the first embodiment.

As illustrated in FIG. 2, in step H1, a plurality of masks is prepared. That is, a plurality of masks M is prepared so that each of a plurality of specific edge directions (hereinbelow, also referred to as a specific edge direction) can take a combination of the masks M with high depth estimation accuracy of an object corresponding to an edge image representing an edge in the specific edge direction.

Here, the mask M has a main aperture as a region through which the light L can pass in an incident region of the light L incident on the optical system 81 used for imaging the subject 90 from the subject 90. In addition, the plurality of masks M is two or more masks in which the positions of the main apertures are different from each other.

In addition, here, it is assumed that four directions of a vertical direction, a horizontal direction, a right oblique direction of 45 degrees, and a left oblique direction of 45 degrees are determined as the specific edge directions. The plurality of masks M to be prepared is, for example, four masks M1 to M4 illustrated in FIG. 1. The masks M1 to M4 have forms in which circular light shielding regions for shielding light are formed on the upper right, the upper left, the lower left, and the lower right of a shielding plate for shielding the light incident region of the optical system 81, respectively. Details of the example of the plurality of masks to be prepared will be described below.

In step H2, non-masked imaging of the subject is performed. That is, the subject 90 is imaged using the optical system 81 and the imaging element 82 in a state where no mask is installed, and a non-masked captured image P0 is obtained. Note that control of the optical system 81 or the imaging element 82 for non-masked imaging is performed by, for example, the arithmetic and control device 91.

In step H3, a representative edge direction in the non-masked captured image is determined. That is, a representative edge direction (hereinbelow referred to as a representative edge direction) considered to be important in the non-masked captured image P0 is determined based on the edge image included in the non-masked captured image P0. The representative edge direction is determined, for example, by selecting it from the plurality of predetermined specific edge directions. Details of an example of a method of determining the representative edge direction will be described below. The representative edge direction is determined by, for example, the arithmetic and control device 91.

In step H4, a combination of masks used for masked imaging is selected. That is, a combination of the masks M with the relatively highest depth estimation accuracy of the object corresponding to the edge image representing the edge in the same direction as the determined representative edge direction is selected from the plurality of the masks M prepared in advance. In other words, among the combinations of the masks M, a combination of the masks M in which the specific edge direction with high depth estimation accuracy is the same as or close to the determined representative edge direction is selected as a combination of the masks M used for coded imaging.

Note that the combination of the masks M with the relatively highest depth estimation accuracy of the object corresponding to the image representing the edge in the same direction as the representative edge direction is two or more masks where the direction in which the respective main apertures or light shielding regions are positionally different is orthogonal to the representative edge direction.

In step H5, the masked imaging of the subject using the first mask is performed. That is, in a state where the first mask included in the selected mask combination is installed, the masked imaging of the same subject 90 using the optical system 81 and the imaging element 82, that is, the coded imaging, is performed. By performing this masked imaging, a first masked captured image P1 is obtained.

In step H6, the masked imaging of the subject using the second mask is performed. That is, in a state where the second mask included in the selected mask combination is installed, the masked imaging of the same subject 90 using the optical system 81 and the imaging element 82, that is, the coded imaging, is performed. By performing this masked imaging, a second masked captured image P2 is obtained. Note that control of the optical system 81 or the imaging element 82 for the masked imaging is performed by, for example, the arithmetic and control device 91.

In step H7, decoding processing of the masked captured image is performed. That is, decoding is performed on the first masked captured image P1 and the second masked captured image P2 by deconvolution based on a point spread function unique to each of the two masks used. By performing this decoding processing, a decoded image in which blurring of the subject is improved is obtained, and information that enables the depth of the object corresponding to each position in the decoded image to be estimated is obtained. Note that the decoding processing is performed by, for example, the arithmetic and control device 91.

Note that the point spread function unique to the mask used is determined by the geometric pattern of the aperture or light shielding region of the mask, the configuration of the optical system, the configuration of the imaging element, the positional relationship among the mask, the optical system, and the imaging element, and the like. Furthermore, the decoding processing in step H7 may be, for example, decoding processing described in a publicly known document in the field of coded imaging such as Non-Patent Document 1.

In step H8, depth estimation of the object corresponding to each position in the decoded image is performed. That is, a depth estimation value of the object corresponding to each position in the decoded image obtained in step H7 is obtained based on the information obtained in step H7. Thereafter, a depth map of the subject may be generated based on the decoded image and the depth estimation value of the object corresponding to each position in the decoded image. Note that derivation of the depth estimation value or generation of the depth map is performed by, for example, the arithmetic and control device 91.

### <Example of Plurality of Masks>

Here, an example of a plurality of masks prepared in advance will be described. Note that, here, an incident region of light coming from the subject and entering the optical system (hereinbelow, the region is also referred to as a light incident region) is a circular region having a substantially perfect circular outline.

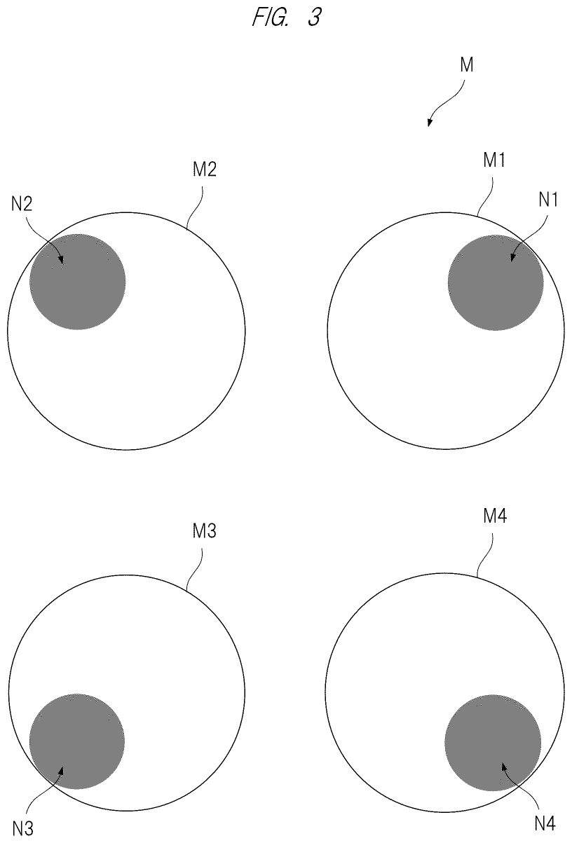

FIG. 3 is a diagram illustrating an example of a plurality of masks. The plurality of masks to be prepared are, for example, masks M1 to M4 illustrated in FIG. 3. The masks M1 to M4 illustrated in FIG. 3 are obtained by enlarging the masks M1 to M4 illustrated in FIG. 1. Note that the masks M1 to M4 indicate patterns of the masks when viewed in a direction in which light from the subject is incident.

As illustrated in FIG. 3, the masks M1 to M4 have forms in which circular light shielding regions N1 to N4 for shielding light are formed on the upper right, the upper left, the lower left, and the lower right of a shielding body for shielding the light incident region of the optical system 81, respectively. The mask M1 is a mask having a pattern in which light is shielded only in a circular region inscribed in an upper right ¼ region of a circular region that is a light incident region and light is transmitted in the other regions. That is, the mask M1 has the circular light shielding region N1 on the upper right of the light incident region.

The mask M2 is a mask having a pattern in which light is shielded only in a circular region inscribed in an upper left ¼ region of the circular region that is a light incident region and light is transmitted in the other regions. That is, the mask M2 has the circular light shielding region N2 on the upper left of the light incident region.

The mask M3 is a mask having a pattern in which light is shielded only in a circular region inscribed in a lower left ¼ region of the circular region that is a light incident region and light is transmitted in the other regions. That is, the mask M3 has the circular light shielding region N3 on the lower left of the light incident region.

Furthermore, the mask M4 is a mask having a pattern in which light is shielded only in a circular region inscribed in a lower right ¼ region of the circular region that is a light incident region and light is transmitted in the other regions. That is, the mask M4 has the circular light shielding region N4 on the lower right of the light incident region.

<Correspondence Relationship Between Combination of Masks and Edge Direction with High Depth Estimation Accuracy>

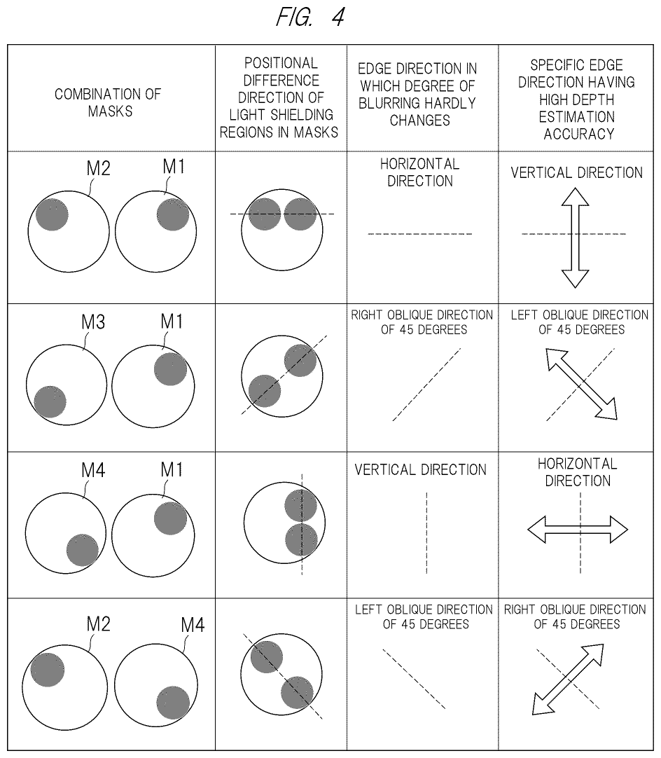

FIG. 4 is a diagram illustrating a correspondence relationship between a combination of masks and an edge direction with high depth estimation accuracy.

In the case of the combination of the mask M1 and the mask M2, the positional difference direction of the light shielding regions in the respective masks is a horizontal direction. Therefore, in the case of the combination of the mask M1 and the mask M2, the edge direction in which the degree of blurring hardly changes between the masked captured images is a horizontal direction. On the other hand, the edge direction in which the degree of blurring easily changes between the masked captured images is a vertical direction orthogonal to the horizontal direction, which is the positional difference direction. That is, in the case of the combination of the mask M1 and the mask M2, the edge direction in which the depth information of the subject easily appears and the depth estimation accuracy is high is the vertical direction.

In the case of the combination of the mask M1 and the mask M3, the positional difference direction of the light shielding regions in the respective masks is a right oblique direction of 45 degrees. The right oblique direction of 45 degrees is a direction of a straight line obtained by rotating a vertical straight line clockwise by 45 degrees. Therefore, in the case of the combination of the mask M1 and the mask M3, the edge direction in which the degree of blurring hardly changes between the masked captured images is a right oblique direction of 45 degrees. On the other hand, the edge direction in which the degree of blurring easily changes between the masked captured images is a left oblique direction of 45 degrees orthogonal to the right oblique direction of 45 degrees, which is the positional difference direction. The left oblique direction of 45 degrees is a direction of a straight line obtained by rotating a vertical straight line counterclockwise by 45 degrees. That is, in the case of the combination of the mask M1 and the mask M3, the edge direction in which the depth information of the subject easily appears and the depth estimation accuracy is high is the left oblique direction of 45 degrees.

In a similar way of thinking, in the case of the combination of the mask M1 and the mask M4, the edge direction in which the depth estimation accuracy is high is the horizontal direction.

In addition, in the case of the combination of the mask M2 and the mask M4, the edge direction in which the depth estimation accuracy is high is the right oblique direction of 45 degrees.

When the edge directions with high depth estimation accuracy are made to correspond to the combinations of masks, the following correspondence relationship is obtained as illustrated in FIG. 4.
(1) Combination of masks M1 and M2: vertical direction
(2) Combination of masks M1 and M3: left oblique direction of 45 degrees
(3) Combination of masks M1 and M4: horizontal direction
(4) Combination of masks M2 and M4: right oblique direction of 45 degrees

### <Examples of Method of Determining Representative Edge Direction>

Examples of a method of determining a representative edge direction in a non-masked captured image will be described. Examples of a method of determining a representative edge direction include the following methods.

### <<First Method of Determining Representative Edge Direction>>

A first method is a method of determining a representative edge direction based on an edge image of a detected specific target object.

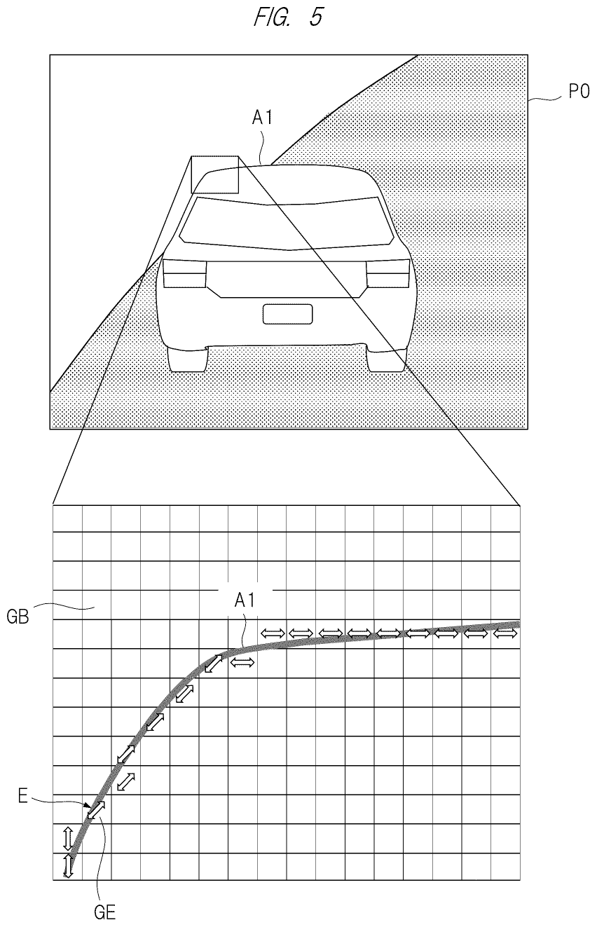

FIG. 5 is a diagram for explaining a first method of determining a representative edge direction.

First, setting of a target object of interest is performed in advance. In a case where the depth estimation of the subject is used in the technical field of automobile driving assistance, the target object of interest is, for example, an automobile, a motorcycle, a bicycle, a wheelchair, a human, a dog, a utility pole, a traffic light, or the like.

Subsequently, as illustrated in FIG. 5, a set target object A1, which is a target object that is set, is searched in the non-masked captured image P0. In FIG. 5, the non-masked captured image P0 is an example of an image obtained by imaging the front from a traveling automobile, and is an example in a case where an automobile is detected as the set target object A1. Note that, for the search for the set target object A1, a detection method by template matching, a detection method by AI, which is artificial intelligence, or the like is used.

Subsequently, in a case where the set target object A1 is detected in the non-masked captured image P0, a representative edge direction is determined based on an edge image corresponding to an edge of the detected set target object A1.

Specifically, for example, a plurality of partial image regions GB is set in the non-masked captured image P0. The plurality of partial image regions GB is set by dividing the entire image region of the non-masked captured image P0 in a lattice shape, that is, a matrix shape. The partial image region GB is, for example, an image region having height×width of 5 pixels×5 pixels.

Subsequently, as illustrated in FIG. 5, an edge direction E of the corresponding edge image is obtained for each partial edge image region GE including the edge of the detected set target object A1 out of the set partial image regions GB. The edge direction E for each partial edge image region GE is obtained by selecting it from the specific edge directions SE associated with the respective combinations of the masks M and having high depth estimation accuracy of the object. To obtain the edge direction E of the partial edge image region GE, the specific edge direction SE in which the angular difference from the edge direction of the actual partial edge image region GE is the smallest is selected from the specific edge directions SE.

The number of the edge directions E obtained for the respective partial edge image regions GE is counted for each specific edge direction SE, and the specific edge direction SE having the largest number is determined as a representative edge direction DE.

### <<Second Method of Determining Representative Edge Direction>>

A second determination method is a method of determining a representative edge direction based on an edge image of an image region with less variation in shading or color.

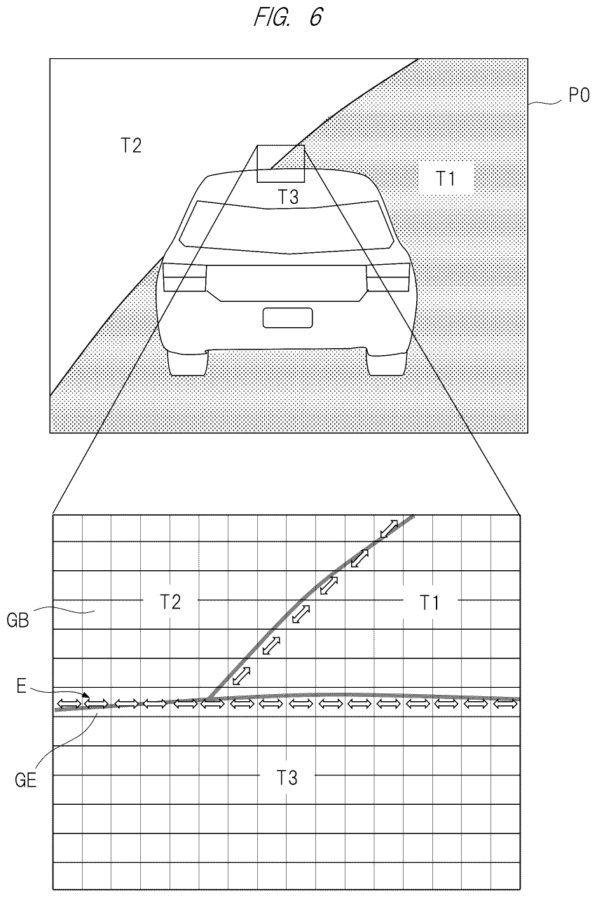

FIG. 6 is a diagram for explaining the second method of determining a representative edge direction.

First, as illustrated in FIG. 6, flat regions T1, T2, . . . , each of which is a continuous region in which the degree of variation in shading or color is equal to or less than an upper limit level and is a region having an area equal to or greater than a threshold value, are searched in the non-masked captured image P0. Each of the flat regions T1, T2, . . . is, for example, a continuous region in which the variance or standard deviation of pixel values is equal to or less than a set upper limit value, and is a region in which the area included in the region, that is, the number of pixels, is equal to or more than a set threshold value.

Subsequently, in a case where the flat regions T1, T2, . . . are detected in the non-masked captured image P0, a representative edge direction DE is determined based on an edge image corresponding to the boundary of the detected flat regions T1, T2, . . . .

Specifically, for example, a plurality of partial image regions GB is set in the non-masked captured image P0. The plurality of partial image regions GB is set by dividing the entire image region of the non-masked captured image P0 in a matrix shape. The partial image region GB is, for example, an image region having height×width of 5 pixels×5 pixels.

Then, as illustrated in FIG. 6, an edge direction E is obtained for each partial edge image region GE corresponding to the boundary of the detected flat regions T1, T2, . . . out of the set partial image regions GB. To obtain the edge direction E for each partial edge image region GE, the edge direction in which the angular difference from the edge direction of the actual partial edge image region GE is the smallest is selected from the specific edge directions SE associated with the respective combinations of the masks M and having high depth estimation accuracy of the object.

The number of the edge directions E of the partial edge image regions GE is counted for each specific edge direction SE, and the specific edge direction SE having the largest number is determined as a representative edge direction DE.

### <<Third Method of Determining Representative Edge Direction>>

A third method is a method of setting a plurality of partial image regions in a non-masked captured image and determining a representative edge direction based on edge images included in the partial image regions.

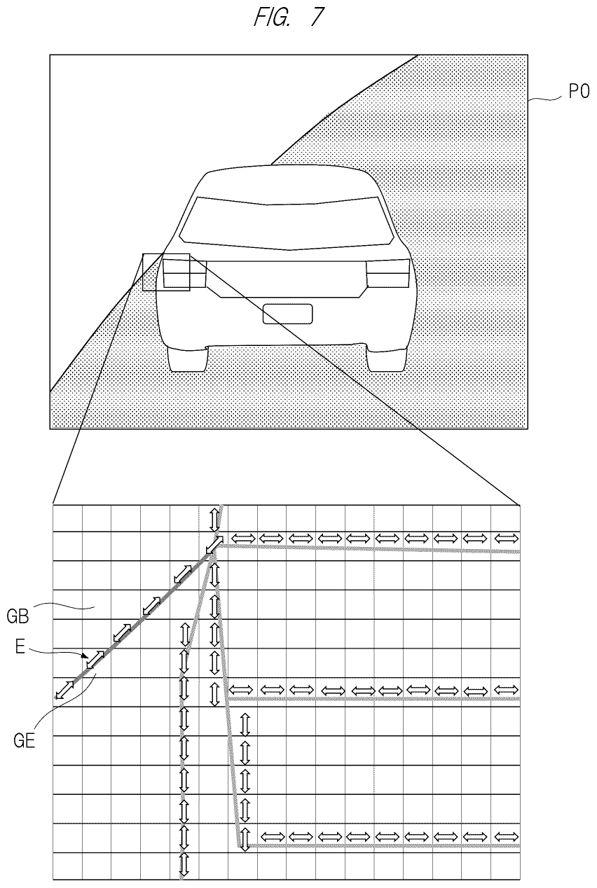

FIG. 7 is a diagram for explaining a third method of determining a representative edge direction.

First, as illustrated in FIG. 7, a plurality of partial image regions GB is set in the non-masked captured image P0. The plurality of partial image regions GB is set by dividing the entire image region of the non-masked captured image P0 in a matrix shape. The partial image region GB is, for example, an image region having height×width of 5 pixels×5 pixels.

Subsequently, for each of the specific edge directions SE associated with the respective combinations of the masks M and having high depth estimation accuracy of the object, it is determined whether or not each of the plurality of partial image regions GB includes an edge in the specific edge direction SE. Note that, in the determination, in a case where the angular difference between the specific edge direction SE and the direction of the actual edge included in the partial image region GB is within a predetermined tolerance, it is determined that the edge in the specific edge direction SE is included in the partial image region GB.

Subsequently, the number of edges in the edge direction determined to be included in the partial image region GB is counted for each specific edge direction SE. Then, the edge direction having the largest number is determined as the representative edge direction DE.

Note that the method of determining the representative edge direction DE is not limited to any one of the first method to the third method. In addition, the method of determining the representative edge direction DE may be a method in which two or more of the first method to the third method are combined. For example, an order of priority may be set for two or more of the first method to the third method, and the two or more methods may be conducted according to the priority order until the representative edge direction DE is determined.

### <<About Edge Image>>

Here, features of an image that is preferably treated as an edge image in the present embodiment will be described.

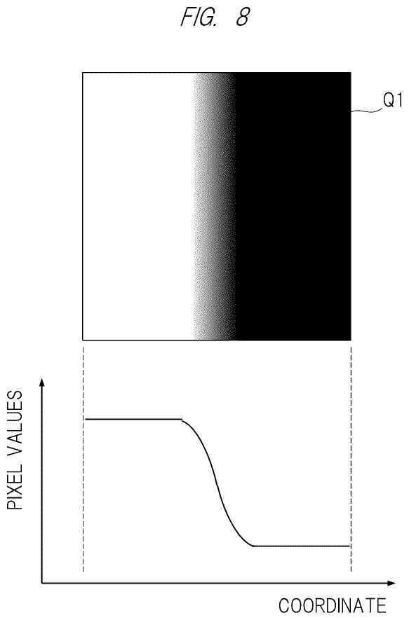

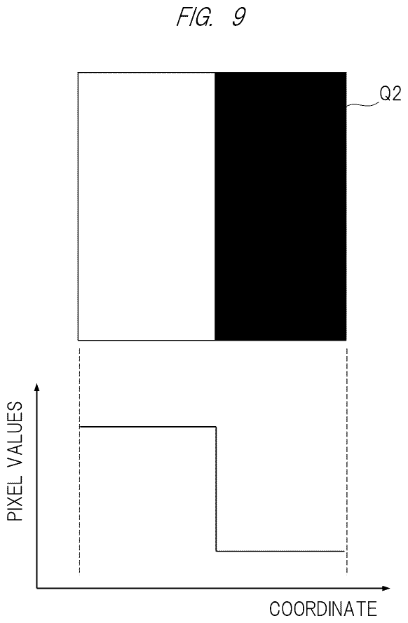

FIG. 8 is a diagram illustrating an example of a blurred edge image. FIG. 9 is a diagram illustrating an example of a sharp edge image.

In the present embodiment, it is preferable to treat an image representing a so-called blurred edge as an edge image. For example, as illustrated in FIG. 8, an image Q1 in which the pixel value changes gradually or gently with respect to the change in the coordinate position is a blurred edge image. To give a more specific example, an image in which five pixels are arranged in one direction and the pixel values are, for example, 180, 150, 100, 50, and 30 in a 256 grayscale image is a so-called blurred edge image. In a case where decoding processing is performed on such a blurred edge image, depth information of an object corresponding to the edge image can be satisfactorily extracted, and highly accurate depth estimation can be performed.

On the other hand, in the present embodiment, it is preferable not to treat an image representing a so-called sharp edge as an edge image. For example, as illustrated in FIG. 9, an image Q2 in which pixel values change steeply with respect to the change in the coordinate position is a sharp edge image. To give a more specific example, an image in which five pixels are arranged in one direction and the pixel value are, for example, 180, 180, 30, 30, and 30 in a 256 grayscale image is a so-called sharp edge image. Such a sharp edge image originally has no or almost no blur. Therefore, in such a sharp edge image, the distance coincides with the photographing distance (distance between the subject and the optical system) calculated from the focal length of the optical system. However, in an optical system having a short focal length, the depth of field becomes deep, a wide range is in focus, and it is difficult to perform highly accurate depth estimation.

As described above, in the subject depth estimation method according to the first embodiment, first, a representative edge direction regarded as important is determined in a non-masked captured image of a subject acquired in advance. Then, as a combination of masks used for masked imaging of the subject necessary for the depth estimation of the subject in the captured image, a combination of masks with the relatively highest depth estimation accuracy of the object corresponding to the edge image in the representative edge direction is selected from a plurality of masks prepared in advance.

Therefore, with the subject depth estimation method according to the first embodiment, it is possible to estimate the depth of the corresponding object with more stable and higher accuracy for the edge image in the representative edge direction that is regarded as important in the captured image. Therefore, with the subject depth estimation method according to the first embodiment, it is possible to provide a more practical DFD technique.

### Second Embodiment

An imaging apparatus according to a second embodiment of the present application will be described. An imaging apparatus according to a second embodiment of the present application is an imaging apparatus including an optical system on which light from a subject is incident, an imaging element which receives the light passing through the optical system, a mask installation unit which creates a state in which any of a plurality of masks prepared in advance is installed and a state in which none of the masks is installed in an incident region of the light incident on the optical system from the subject, and an arithmetic and control unit which outputs a signal for controlling the mask installation unit and the imaging element so that the subject is imaged and acquires a non-masked captured image of the subject and a masked captured image of the subject. The arithmetic and control unit performs non-masked imaging processing of obtaining the non-masked captured image by imaging the subject in a state where no mask is installed, determination processing of determining a representative edge direction based on an edge image included in the non-masked captured image, selection processing of selecting, from among the plurality of the masks prepared in advance, a combination of the masks with a relatively highest depth estimation accuracy of an object corresponding to an image representing an edge in an equal direction to the representative edge direction, masked imaging processing of obtaining a plurality of masked captured images by imaging the subject using each of the masks included in the selected combination of the masks, and decoding processing of obtaining information indicating a depth of the subject at each of a plurality of positions by performing decoding, based on a point spread function unique to each of the masks selected, on the plurality of masked captured images. Details of the present imaging apparatus are as follows.

### <Example of Configuration of Imaging Apparatus>

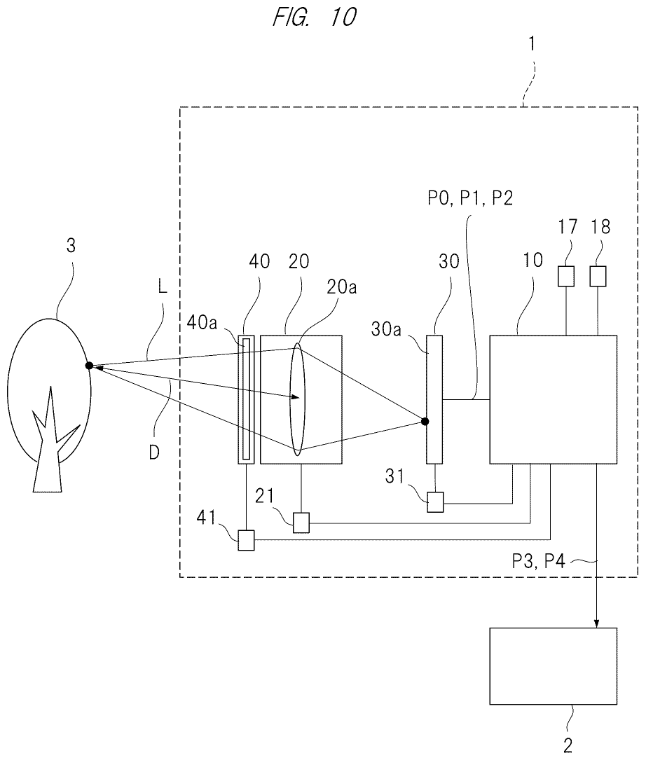

FIG. 10 is a diagram illustrating an example of a configuration of an imaging apparatus according to the second embodiment. As illustrated in FIG. 10, an imaging apparatus 1 according to the second embodiment includes an optical system unit 20, an imaging element 30, a liquid crystal mask unit 40, an optical system control unit 21, an imaging element control unit 31, a liquid crystal mask control unit 41, and an arithmetic and control unit 10. Note that the “optical system unit 20” is an example of an “optical system” in the present application. The “liquid crystal mask unit 40” is an example of a “mask installation unit” in the present application

The optical system unit 20 collects light L, which is light emitted or reflected from a subject 3, and forms an image on a light receiving surface 30a of the imaging element 30 described below. The optical system unit 20 includes a lens 20a. The lens 20a is, for example, a single focus lens or a zoom lens. The lens 20a is generally a compound lens in which a plurality of lenses is combined, but may be a single lens. The optical system unit 20 may be of an autofocus type or a fixed focus type.

The imaging element 30 is an electronic component that performs photoelectric conversion. That is, the imaging element 30 is a device that forms an image of the light L, which is light emitted or reflected from the subject 3, on the light receiving surface 30a of the imaging element 30 through the optical system unit 20, photoelectrically converts brightness due to the light of the image into a charge amount, reads the amount, and converts the amount into an electric signal.

The imaging element 30 generally includes a plurality of photoelectric conversion elements arranged in a two-dimensional array, and the plurality of photoelectric conversion elements forms the light receiving surface 30a. The imaging element 30 is disposed at a position where the light L incident on the optical system unit 20 from the subject 3 and passing through the optical system unit 20 is received by the light receiving surface 30a. The imaging element 30 converts the intensity, that is, the brightness, of the light received by the light receiving surface 30a into an electric signal and outputs an image signal. The imaging element 30) may output a color image signal representing a color image or may output a monochrome image signal representing a monochrome image.

The imaging element 30 includes, for example, a charge-coupled device (CCD) image sensor, a complementary metal oxide semiconductor (COMS) image sensor, or the like.

The liquid crystal mask unit 40 is provided in front of the side of the optical system unit 20 close to the subject 3. The liquid crystal mask unit 40 has a function of causing any of a plurality of predetermined masks M to appear or causing no mask M to appear. The liquid crystal mask unit 40 may be provided inside the optical system unit 20.

In the present embodiment, the liquid crystal mask unit 40 is configured such that any of the masks M1 to M4 can be installed or no mask can be installed on the side of the optical system unit 20 close to the subject 3.

The liquid crystal mask unit 40 includes, for example, a liquid crystal light shutter 40a as illustrated in FIG. 10.

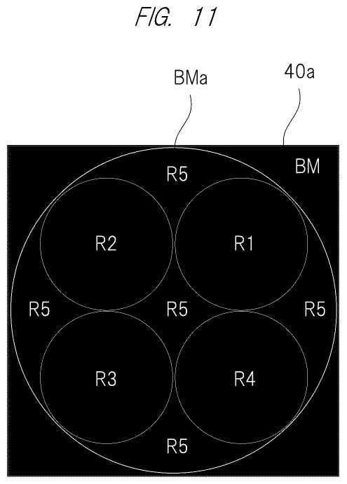

FIG. 11 is a diagram illustrating an example of a liquid crystal light shutter. As illustrated in FIG. 11, the liquid crystal light shutter 40a includes a light shielding portion BM and a plurality of segments R1 to R5.

The light shielding portion BM has an aperture BMa through which the light L incident on the optical system unit 20 from the subject 3 passes. The light shielding portion BM is made of, for example, a black resin plate or a metal plate.

The segments R1 to R5 are arranged so as to divide the region of the aperture BMa of the light shielding portion BM. The liquid crystal light shutter 40a has electrodes corresponding to the segments R1 to R5, respectively. Each of the segments R1 to R5 is in either a light shielding state or a light transmitting state according to the voltage applied to the corresponding electrode.

The regions of the segments R1 to R4 out of the segments R1 to R5 correspond to the light shielding regions of the masks M1 to M4, respectively. The segment R5 corresponds to a remaining region excluding the regions of the segments R1 to R4 from the region of the aperture BMa of the light shielding portion BM.

By controlling the state of each of the segments R1 to R5, it is possible to achieve a state in which an intended mask is installed or a state in which no mask is installed.

For example, in a case where the segment R1 is set in the light shielding state and the segments R2 to R5 are set in the light transmitting state, a state in which the mask M1 is installed is achieved. Alternatively, in a case where the segment R2 is set in the light shielding state and the segments R1 and R3 to R5 are set in the light transmitting state, a state in which the mask M2 is installed is achieved. In addition, in a case where the segments R1 to R5 are set in the light transmitting state, a state in which no mask is installed, that is, a non-masked state, is achieved.

Note that the liquid crystal mask unit 40 may have a different structure from that of the liquid crystal light shutter. For example, the liquid crystal mask unit 40 may have a structure of having a mechanism for mechanically switching a plurality of masks formed by plate-shaped members. Furthermore, for example, the liquid crystal mask unit 40 may have a structure of having a plurality-of-diaphragm mechanism that covers the entire passage region of light incident on the optical system unit 20 and includes diaphragms capable of opening and closing apertures in a plurality of different positions.

The optical system control unit 21 adjusts the position of a movable portion included in the optical system unit 20 based on a control signal received from the arithmetic and control unit 10. The optical system control unit 21 includes, for example, a drive motor, and moves at least a part of the lens by operating the drive motor.

In a case where the optical system unit 20 includes a zoom lens, the optical system control unit 21 may change a zoom magnification by moving a part of a lens group constituting the zoom lens, or may adjust a focus by moving the entire zoom lens. In a case where the optical system unit 20 includes a single focus lens, the focus may be adjusted by moving the entire lens. In a case where the optical system unit 20 includes a diaphragm mechanism, the aperture diameter of the diaphragm may be adjusted by operating the diaphragm mechanism.

The imaging element control unit 31 executes imaging by reading an image signal output from the imaging element 30 based on a control signal received from the arithmetic and control unit 10. The imaging element control unit 31 transmits the read image signal to the arithmetic and control unit 10. Note that the shutter method of imaging the subject 3 by controlling the imaging element 30 may be, for example, a global shutter method or a rolling shutter method.

The liquid crystal mask control unit 41 controls the liquid crystal mask unit 40 based on a control signal received from the arithmetic and control unit 10 to achieve a state in which the intended mask M is installed in the liquid crystal mask unit 40 or a state in which no mask M is installed.

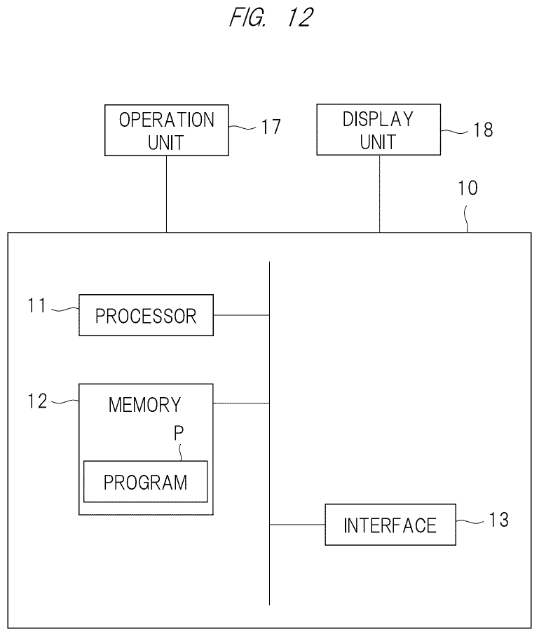

FIG. 12 is a diagram illustrating an example of a configuration of the arithmetic and control unit 10 according to the second embodiment. As illustrated in FIG. 12, the arithmetic and control unit 10 is, for example, a computer, and includes a processor 11, a memory 12, and an interface 13.

The memory 12 stores a program P used when the processor 11 executes various types of arithmetic processing, image processing, or the like, and executes various types of control processing. In addition, the memory 12 stores data to be processed by the processor 11 on a temporary basis or for a long period.

The processor 11 executes various types of processing including arithmetic processing, image processing, and control processing by reading and executing the program P stored in the memory 12. When executing various types of processing, the processor 11 executes processing by storing data in the memory 12 or accessing data stored in the memory 12.

Furthermore, the processor 11 executes, as a part of the various types of processing, non-masked imaging processing, representative edge direction determination processing, mask selection processing, first mask imaging processing, second mask imaging processing, decoding processing, subject depth estimation processing, depth map generation processing, data output processing, and imaging continuation determination processing. Details of these various types of processing will be described below.

The processor 11 transmits a control signal to the optical system control unit 21, the imaging element control unit 31, and the liquid crystal mask control unit 41 in order to execute the above-described non-masked imaging processing, representative edge direction determination mask selection processing, processing, first mask imaging processing, and second mask imaging processing.

The interface 13 is connected to an external device 2, and transmits a decoded image P3 or a depth map P4 generated in the arithmetic and control unit 10 to the external device 2.

Note that all or a part of the computer may include a semiconductor circuit such as a digital signal processor (DSP), an application specific integrated circuit (ASIC), a field programmable gate array (FPGA), and a complex programmable logic device (CPLD).

The external device 2 is, for example, an image processing device, a vehicle driving assistance device, or the like. The image processing device performs, for example, on the captured image, processing of blurring a background far away from the optical system to emphasize a subject of interest. The vehicle driving assistance device, for example, detects a position or a relative moving speed of an object around the vehicle, and issues a warning or controls the vehicle in order to avoid danger.

Note that an operation unit 17 and a display unit 18 are connected to the arithmetic and control unit 10. The operation unit 17 is for receiving an input operation from the user, and the display unit 18 is for visually outputting information for the user. The operation unit 17 is, for example, a keyboard, a mouse, a button, a dial, or the like. The display unit 18 is, for example, a liquid crystal panel, an organic EL panel, or the like. The operation unit 17 and the display unit 18 may be an integrated touch panel. The operation unit 17 and the display unit 18 may be provided on the external device 2.

### <Procedure of Operation of Imaging Apparatus>

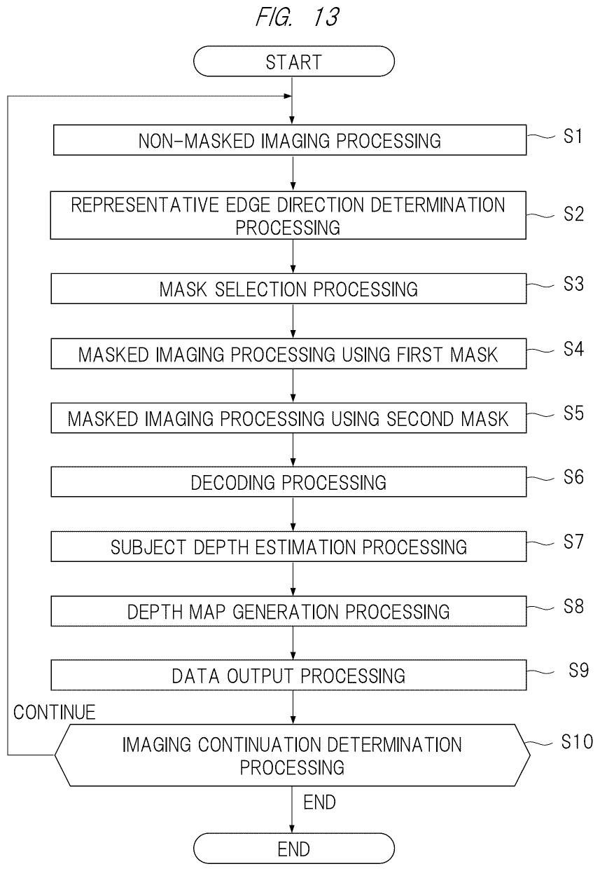

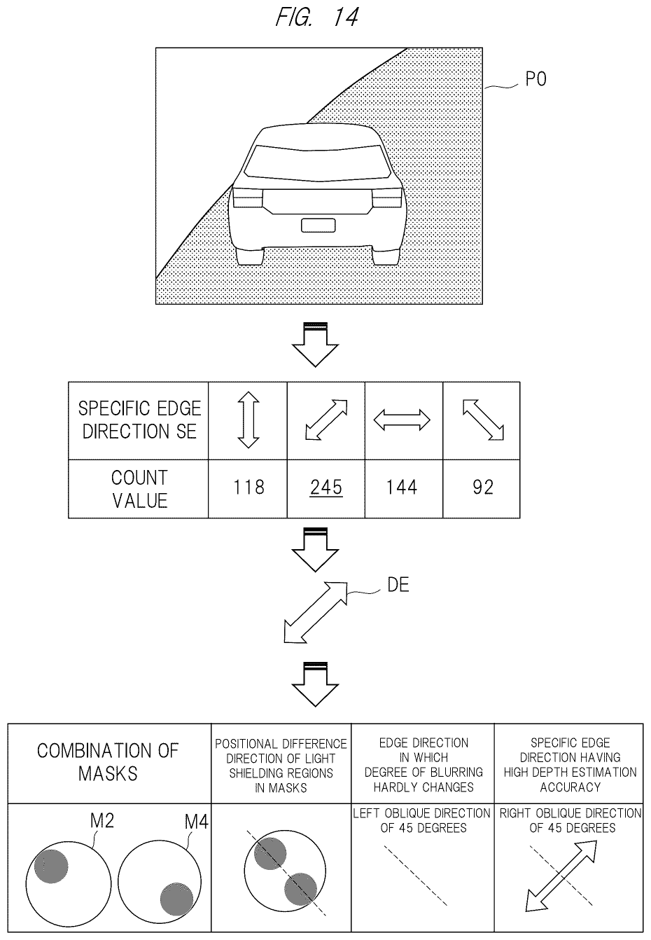

A procedure of operation of the imaging apparatus according to the second embodiment will be described. FIG. 13 is a flowchart illustrating an example of a procedure of operation of the imaging apparatus according to the second embodiment. Furthermore, FIG. 14 is a diagram for describing a procedure from the non-masked imaging processing to the mask selection processing.

As illustrated in FIG. 13, in step S1, the non-masked imaging processing is executed. That is, the non-masked imaging of the subject 3 is performed. Specifically, the arithmetic and control unit 10 transmits a control signal to the liquid crystal mask control unit 41, the optical system control unit 21, and the imaging element control unit 31 such that the subject 3 is imaged in a state where no mask M is installed.

Based on the received control signal, the liquid crystal mask control unit 41 controls the liquid crystal mask unit 40 such that a state in which no mask M is installed is set. That is, the liquid crystal mask control unit 41 controls the liquid crystal mask unit 40 such that the segments R1 to R5 are in the light transmitting state.

Subsequently, based on the received control signal, the optical system control unit 21 controls the optical system unit 20 such that the focal length and the like of the optical system unit 20 are in appropriate conditions as necessary.

Subsequently, based on the received control signal, the imaging element control unit 31 controls the imaging element 30 such that the subject 3 is imaged, that is, the captured image of the subject 3 represented by the output signal of the imaging element 30 is transmitted to the arithmetic and control unit 10.

The non-masked imaging of the subject 3 is performed in the aforementioned manner, whereby the arithmetic and control unit 10 acquires a non-masked captured image P0 of the subject 3 as illustrated in FIG. 14.

In step S2, the representative edge direction determination processing is executed. That is, a representative edge direction DE in the non-masked captured image P0 is determined. Specifically, the arithmetic and control unit 10 determines the representative edge direction DE in the non-masked captured image P0 by using, for example, the above-described method of determining the representative edge direction DE, based on the non-masked captured image P0.

For example, using the third method of determining the representative edge direction described above, the number of edge directions that are the same as or close to the specific edge direction SE is counted for each of the four predetermined specific edge directions SE, and the edge direction having the largest number is determined as the representative edge direction DE. In the example in FIG. 14, since the count value for the specific edge direction SE of the right oblique angle of 45 degrees is the largest, this specific edge direction SE is determined as the representative edge direction DE.

In step S3, the mask selection processing is executed. That is, a combination of the masks M used for the masked imaging is selected. Specifically, the arithmetic and control unit 10 selects a combination of masks M in which the specific edge direction SE with the relatively highest depth estimation accuracy of the subject matches the determined representative edge direction DE from among the plurality of masks M1 to M4.

For example, in a case where the representative edge direction DE is the vertical direction, a combination of the mask M1 and the mask M2 or a combination of the mask M3 and the mask M4 is selected. In a case where the representative edge direction DE is the left oblique direction of 45 degrees, a combination of the mask M1 and the mask M3 is selected. In a case where the representative edge direction DE is the horizontal direction, a combination of the mask M1 and the mask M4 or a combination of the mask M2 and the mask M3 is selected. In a case where the representative edge direction DE is the right oblique direction of 45 degrees, a combination of the mask M2 and the mask M4 is selected.

In the example in FIG. 14, since the representative edge direction DE is the right oblique direction of 45 degrees, a combination of the masks M in which the specific edge direction SE with the relatively highest depth estimation accuracy of the object is the right oblique direction of 45 degrees, that is, a combination of the mask M2 and the mask M4, is selected.

In step S4, the masked imaging processing using the first mask is executed. That is, the masked imaging of the subject 3 using the first mask M out of the selected combination of the masks M is performed. Specifically, the arithmetic and control unit 10 transmits a control signal to the liquid crystal mask control unit 41 and the imaging element control unit 31 such that the subject 3 is imaged in a state where the first mask M is installed.

Based on the received control signal, the liquid crystal mask control unit 41 controls the liquid crystal mask unit 40 such that a state in which the first mask M is installed is set. That is, the liquid crystal mask control unit 41 determines whether each of the segments R1 to R5 is set in the light transmitting state or the light shielding state so that the segments R1 to R5 form the first mask M, and performs the setting.

Subsequently, based on the received control signal, the imaging element control unit 31 controls the imaging element 30 such that the subject 3 is imaged, that is, the captured image of the subject 3 represented by the output signal of the imaging element 30 is transmitted to the arithmetic and control unit 10.

By imaging the subject 3 using the first mask M in the aforementioned manner, the arithmetic and control unit 10 acquires a first masked captured image P1 of the subject 3.

In step S5, the masked imaging processing using the second mask is executed. That is, the masked imaging of the subject 3 using the second mask M included in the selected combination of the masks M is performed. Specifically, the arithmetic and control unit 10 transmits a control signal to the liquid crystal mask control unit 41 and the imaging element control unit 31 such that the subject 3 is imaged in a state where the second mask M is installed.

Based on the received control signal, the liquid crystal mask control unit 41 controls the liquid crystal mask unit 40 such that a state in which the second mask M is installed is set. That is, the liquid crystal mask control unit 41 determines whether each of the segments R1 to R5 is set in the light transmitting state or the light shielding state so that the segments R1 to R5 form the second mask M, and performs the setting.

Subsequently, based on the received control signal, the imaging element control unit 31 controls the imaging element 30 such that the subject 3 is imaged, that is, the captured image of the subject 3 represented by the output signal of the imaging element 30 is transmitted to the arithmetic and control unit 10.

By imaging the subject 3 using the second mask M in the aforementioned manner, the arithmetic and control unit 10 acquires a second masked captured image P2 of the subject 3.

In step S6, the decoding processing is performed. That is, the decoding processing is performed on the masked captured image. Specifically, the arithmetic and control unit 10 performs decoding processing, based on a point spread function unique to the first mask M and a point spread function unique to the second mask M, on the first masked captured image P1 and the second masked captured image P2, respectively. When the decoding processing is performed, a decoded image P3, which is an image in which blurring of the first masked captured image P1 or the second masked captured image P2 is improved, and depth information that enables the depth of the object corresponding to each position in the decoded image P3 to be estimated, are obtained.

In step S7, the subject depth estimation processing is executed. That is, the depth of the object corresponding to each position in the decoded image P3 is estimated. Specifically, the arithmetic and control unit 10 calculates a depth estimation value of the object corresponding to each position in the decoded image P3 based on the depth information obtained in step S6.

In step S8, the depth map generation processing is executed. That is, a depth map P4 is generated. Specifically, the arithmetic and control unit 10 generates the depth map P4 by associating each position in the decoded image P3 with a value representing the depth of the object corresponding to the position. Note that the depth map P4 represents each of a plurality of positions, that is, each pixel or each partial image region, in the captured image and the depth information of the object represented in the pixel or the partial image region in association with each other.

In step S9, the data output processing is executed. That is, the decoded image P3 and the depth map P4 are output. Specifically, the arithmetic and control unit 10 outputs the decoded image P3 and the depth map P4 to the external device 2 via the interface 13.

In step S10, the imaging continuation determination processing is executed. That is, it is determined whether or not to continue imaging. For example, in a case where a signal for requesting stop of imaging is input by operation of the operation unit 17 by the user or processing executed by the external device 2, or in a case where an error has occurred from what source, the arithmetic and control unit 10 determines to stop imaging. On the other hand, for example, in a case where there is no input of a signal requesting stop of imaging, occurrence of an error, or the like, the arithmetic and control unit 10 determines to continue imaging.

In a case where it is determined to stop imaging, the arithmetic and control unit 10 stops imaging and terminates the processing. On the other hand, in a case where it is determined that imaging is to be continued, the arithmetic and control unit 10 returns the processing step to be executed to step S1 and continues the processing.

As described above, in the imaging apparatus 1 according to the second embodiment, first, a representative edge direction regarded as important is determined in a non-masked captured image of a subject acquired in advance. Then, as a combination of masks used for masked imaging of the subject necessary for the depth estimation of the subject in the captured image, a combination of masks with the relatively highest depth estimation accuracy of the object corresponding to the edge image in the representative edge direction is selected from a plurality of masks prepared in advance.

Therefore, with the imaging apparatus 1 according to the second embodiment, it is possible to estimate the depth of the corresponding object with more stable and higher accuracy for the edge image in the representative edge direction that is regarded as important in the captured image. Therefore, with the imaging apparatus 1 according to the second embodiment, it is possible to provide a more practical DFD technique.

Further, according to the second embodiment, a state in which an intended mask is installed or a state in which no mask is installed is achieved by the liquid crystal light shutter. The liquid crystal light shutter can achieve installation of a freely-selected mask merely by the design of the segments, and it is not necessary to physically switch hardware for switching the state of the mask. Therefore, the position of the mask can be controlled accurately, and the mechanism for switching the mask can also be simplified.

### First Modification Example

A first modification example will be described. In the first embodiment and the second embodiment, the specific edge direction SE with high depth estimation accuracy corresponding to the combination of masks has four types, which are the vertical direction, the left oblique direction of 45 degrees, the horizontal direction, and the right oblique direction of 45 degrees. However, the specific edge direction and the combination of masks corresponding to the specific edge direction may each have five or more types.

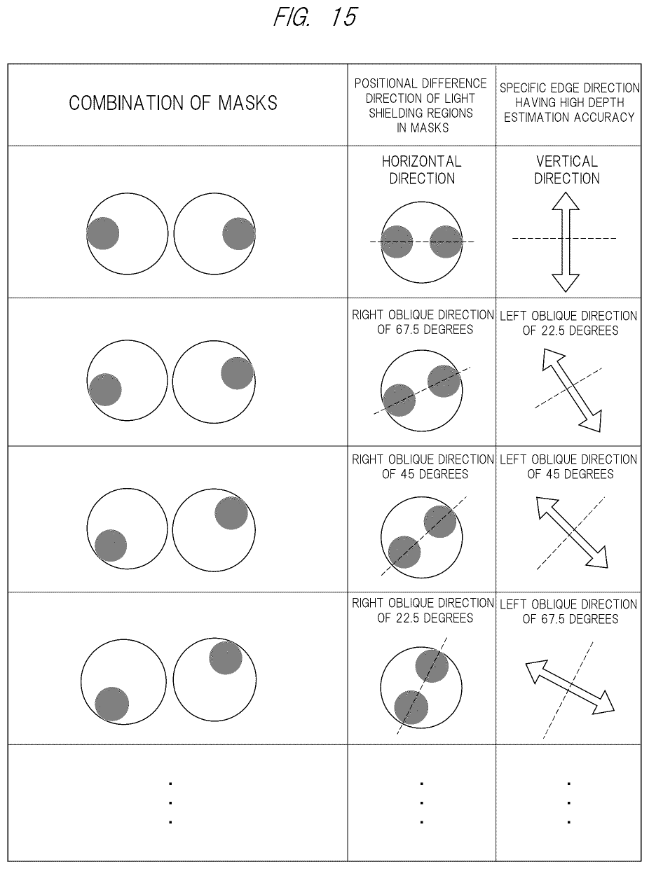

FIG. 15 is a diagram illustrating an example of a plurality of types of combinations of masks according to the first modification example. The example in FIG. 15 is an example of combinations of masks prepared such that the specific edge direction SE with high depth estimation accuracy of the object is set at angular intervals of 22.5 degrees with reference to the vertical direction. That is, the prepared combinations of masks are 16 types of combinations in which the specific edge direction SE is a vertical direction, a left oblique direction of 22.5 degrees, a left oblique direction of 45 degrees, a left oblique direction of 67.5 degrees, . . . , and a right oblique direction of 22.5 degrees.

Note that, in the first modification example, the liquid crystal mask unit 40 is configured such that the five or more types of combinations of masks described above can be formed. That is, the segment division in the liquid crystal light shutter 40a is designed so that these masks can be formed.

According to such a first modification example, the number of the specific edge directions SE with high depth estimation accuracy of the object is larger. Therefore, the representative edge direction can be determined in the direction of a finer angle, and the depth of the corresponding object can be estimated with higher accuracy for the edge image in the representative edge direction that is regarded as important.

### Second Modification Example

A second modification example will be described. In the first embodiment, the second embodiment, and the first modification example, a combination of two masks is selected as a combination of masks used for the masked imaging. However, as a combination of masks used for the masked imaging, a combination of three or more masks may be selected. The second modification example is an example in which a combination of three or more masks is selected as a combination of masks used for the masked imaging.

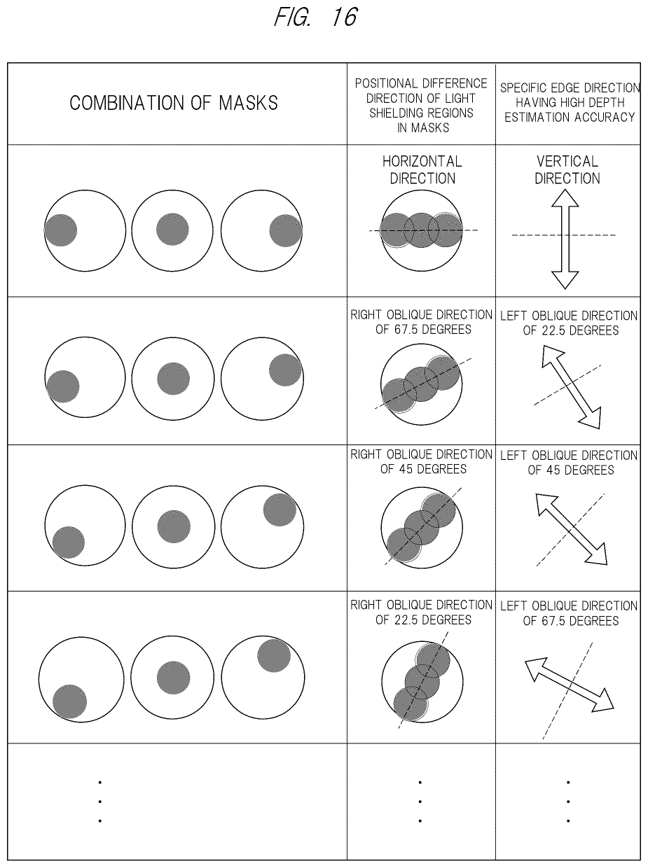

FIG. 16 is a diagram illustrating an example of combinations of masks according to the second modification example. In the example in FIG. 16, an example of a combination of three masks is illustrated. For example, as illustrated in FIG. 16, a combination of three masks in which the light shielding regions in the masks are aligned in one positional difference direction may be prepared as a selection candidate.

According to such a second modification example, as well as the first embodiment, it is possible to estimate the depth of the corresponding object with higher accuracy for the edge image in the representative edge direction that is regarded as important in the captured image.

### Third Modification Example

In the second embodiment, the component forming the mask in the imaging apparatus is the liquid crystal mask unit 40, but of course, the present invention is not limited thereto. For example, a plurality of types of mask plates each of which is a plate-like member provided with an aperture may be prepared, and the mask plates may be mechanically switched in front of the side of the optical system unit 20 close to the subject to bring about a state in which a desired mask is installed.

### Third Embodiment

A program according to a third embodiment of the present application will be described. A program according to a third embodiment of the present application is a program for causing a computer to perform non-masked imaging processing of obtaining a non-masked captured image by imaging a subject in a state where no mask is installed, determination processing of determining a representative edge direction based on an edge image included in the non-masked captured image, selection processing of selecting, from among a plurality of the masks prepared in advance, a combination of the masks with a relatively highest depth estimation accuracy of an object corresponding to an image representing an edge in an equal direction to the representative edge direction, masked imaging processing of obtaining a plurality of masked captured images by imaging the subject using each of the masks included in the selected combination of the masks, and decoding processing of obtaining information indicating a depth of the subject at each of a plurality of positions by performing decoding, based on a point spread function unique to each of the masks selected, on the plurality of masked captured images.

The present program may be a program for causing a computer to execute the subject depth estimation method according to the first embodiment. Furthermore, the present program may be a program for causing a computer to function as the arithmetic and control unit 10 included in the imaging apparatus according to the second embodiment.

Note that a non-transitory tangible computer-readable recording medium in which the program is recorded is also an embodiment of the present invention. By causing the computer to execute the program, it is possible to obtain a similar effect to the effect of the imaging apparatus 1 according to the second embodiment.

Although various embodiments of the present invention have been described above, the present invention is not limited to the above-described embodiments, includes various and modification examples. In addition, the above-described embodiments have been described in detail in order to describe the present invention in an easy-to-understand manner, and are not necessarily limited to those having all the described components. Further, one of the components of an embodiment can be replaced with a component of another embodiment, and a component of another embodiment may be added to the components of an embodiment. These are all within the scope of the present invention. Furthermore, numerical values and the like included in the text and the drawings are illustrative only, and the effect of the present invention is not impaired even if different ones are used.

What is claimed is:

1. An imaging apparatus comprising:
an optical system on which light from a subject is incident;
an imaging element which receives the light passing through the optical system;
a mask installation unit which creates a state in which any of a plurality of masks prepared in advance is installed and a state in which none of the masks is installed in an incident region of the light incident on the optical system from the subject; and
an arithmetic and control unit which outputs a signal for controlling the mask installation unit and the imaging element so that the subject is imaged and acquires a non-masked captured image of the subject and a masked captured image of the subject,
wherein the arithmetic and control unit performs
non-masked imaging processing of obtaining the non-masked captured image by imaging the subject in a state where no mask is installed,
determination processing of determining a representative edge direction based on an edge image included in the non-masked captured image,
selection processing of selecting, from among the plurality of the masks prepared in advance, a combination of the masks with a relatively highest depth estimation accuracy of an object corresponding to an image representing an edge in an equal direction to the representative edge direction,
masked imaging processing of obtaining a plurality of masked captured images by imaging the subject using each of the masks included in the selected combination of the masks, and
decoding processing of obtaining information indicating a depth of the subject at each of a plurality of positions by performing decoding, based on a point spread function unique to each of the masks selected, on the plurality of masked captured images.

2. The imaging apparatus according to claim 1,
wherein the mask has a light shielding region in a part of the incident region of the light, and
wherein the plurality of the masks is two or more of the masks in which positions of the light shielding regions are different from each other.

3. The imaging apparatus according to claim 2,
wherein the combination of the masks with the relatively highest depth estimation accuracy of the object corresponding to the image representing the edge in the equal direction to the representative edge direction is two or more of the masks where a direction in which respective main apertures are positionally different is orthogonal to the representative edge direction.

4. The imaging apparatus according to claim 1,
wherein the determination processing is processing of detecting a predetermined target object in the non-masked captured image and determining the representative edge direction based on an edge image corresponding to a boundary of the target object detected.

5. The imaging apparatus according to claim 2,
wherein the determination processing is processing of detecting a predetermined target object in the non-masked captured image and determining the representative edge direction based on an edge image corresponding to a boundary of the target object detected.

6. The imaging apparatus according to claim 1,
wherein the determination processing is processing of detecting a region which is a continuous region in which a degree of variation in shading or color is equal to or less than an upper limit level and is a region having an area equal to or greater than a threshold value in the non-masked captured image, and determining the representative edge direction based on an edge image corresponding to a boundary of the region detected.

7. The imaging apparatus according to claim 2,
wherein the determination processing is processing of detecting a region which is a continuous region in which a degree of variation in shading or color is equal to or less than an upper limit level and is a region having an area equal to or greater than a threshold value in the non-masked captured image, and determining the representative edge direction based on an edge image corresponding to a boundary of the region detected.

8. The imaging apparatus according to claim 1,
wherein the determination processing is processing of setting a plurality of partial image regions in the non-masked captured image and determining the representative edge direction based on edge images included in the partial image regions.

9. The imaging apparatus according to claim 2,
wherein the determination processing is processing of setting a plurality of partial image regions in the non-masked captured image and determining the representative edge direction based on edge images included in the partial image regions.

10. The imaging apparatus according to claim 1,
wherein the mask installation unit includes a liquid crystal light shutter.

11. A subject depth estimation method comprising the steps of:
obtaining a non-masked captured image by imaging a subject in a state where no mask is installed;
determining a representative edge direction based on an edge image included in the non-masked captured image;
selecting, from among a plurality of masks prepared in advance, a combination of the masks with a relatively highest depth estimation accuracy of an object corresponding to an image representing an edge in an equal direction to the representative edge direction;
obtaining a plurality of masked captured images by imaging the subject using each of the masks included in the selected combination of the masks; and
obtaining information indicating a depth of the subject at each of a plurality of positions by performing decoding, based on a point spread function unique to each of the masks selected, on the plurality of masked captured images.

12. The subject depth estimation method according to claim 11,
wherein the mask has a light shielding region in a part of an incident region of light incident on an optical system used for imaging the subject from the subject, and
wherein the plurality of the masks is two or more of the masks in which positions of the light shielding regions are different from each other.

13. The subject depth estimation method according to claim 12,
wherein the combination of the masks with the relatively highest depth estimation accuracy of the object corresponding to the image representing the edge in the equal direction to the representative edge direction is two or more of the masks where a direction in which the respective light shielding regions are positionally different is orthogonal to the representative edge direction.

14. The subject depth estimation method according to claim 11,
wherein a predetermined target object is detected in the non-masked captured image, and the representative edge direction is determined based on an edge image corresponding to a boundary of the target object detected.

15. The subject depth estimation method according to claim 12,
wherein a predetermined target object is detected in the non-masked captured image, and the representative edge direction is determined based on an edge image corresponding to a boundary of the target object detected.

16. The subject depth estimation method according to claim 11,
wherein a region which is a continuous region in which a degree of variation in shading or color is equal to or less than an upper limit level and is a region having an area equal to or greater than a threshold value is detected in the non-masked captured image, and the representative edge direction is determined based on an edge image corresponding to a boundary of the region detected.

17. The subject depth estimation method according to claim 12,
wherein a region which is a continuous region in which a degree of variation in shading or color is equal to or less than an upper limit level and is a region having an area equal to or greater than a threshold value is detected in the non-masked captured image, and the representative edge direction is determined based on an edge image corresponding to a boundary of the region detected.

18. The subject depth estimation method according to claim 11,
wherein a plurality of partial image regions is set in the non-masked captured image, and the representative edge direction is determined based on edge images included in the partial image regions.

19. The subject depth estimation method according to claim 12,
wherein a plurality of partial image regions is set in the non-masked captured image, and the representative edge direction is determined based on edge images included in the partial image regions.

20. A program for causing a computer to perform:
non-masked imaging processing of obtaining a non-masked captured image by imaging a subject in a state where no mask is installed;
determination processing of determining a representative edge direction based on an edge image included in the non-masked captured image;
selection processing of selecting, from among a plurality of the masks prepared in advance, a combination of the masks with a relatively highest depth estimation accuracy of an object corresponding to an image representing an edge in an equal direction to the representative edge direction;
masked imaging processing of obtaining a plurality of masked captured images by imaging the subject using each of the masks included in the selected combination of the masks; and
decoding processing of obtaining information indicating a depth of the subject at each of a plurality of positions by performing decoding, based on a point spread function unique to each of the masks selected, on the plurality of masked captured images.
